(19) United States
(12) Patent Application Publication
(10) Pub. No.: US 2025/0200726 A1
(43) Pub. Date: Jun. 19, 2025

(54) GUIDED DENOISING WITH EDGE PRESERVATION FOR VIDEO SEE-THROUGH (VST) EXTENDED REALITY (XR)

(71) Applicant: Samsung Electronics Co., Ltd., Suwon-si (KR)

(72) Inventors: Yingen Xiong, Mountain View, CA (US); Christopher A. Peri, Mountain View, CA (US)

(21) Appl. No.: 18/787,816

(22) Filed: Jul. 29, 2024

Related U.S. Application Data
(60) Provisional application No. 63/610,246, filed on Dec. 14, 2023.

(51) Int. Cl. G06T 5/70; G06T 5/20; G06T 7/50; G06T 7/90; G06V 10/771

(52) U.S. Cl. CPC G06T 5/70; G06T 5/20; G06T 7/50; G06T 7/90; G06V 10/771; G06T 2207/10024

(57) ABSTRACT

A method includes obtaining, using at least one imaging sensor, an image frame. The method also includes mapping, using at least one processing device, the image frame to a mesh including multiple vertices. The method further includes performing, using the at least one processing device, noise reduction to determine color data of pixels located on the vertices of the mesh. Performing the noise reduction includes using a denoising filter to denoise the image frame. The method also includes determining, using the at least one processing device, color data of remaining pixels not located on the vertices of the mesh based on the determined color data of the pixels located on the vertices to generate a denoised image. In addition, the method includes performing, using the at least one processing device, image enhancement of the denoised image to enhance at least part of the denoised image and generate an enhanced image.

### CROSS-REFERENCE TO RELATED APPLICATION AND PRIORITY CLAIM

This application claims priority under 35 U.S.C. § 119 (e) to U.S. Provisional Patent Application No. 63/610,246 filed on Dec. 14, 2023. This provisional patent application is hereby incorporated by reference in its entirety.

### TECHNICAL FIELD

This disclosure relates generally to extended reality (XR) systems and processes. More specifically, this disclosure relates to guided denoising with edge preservation for video see-through (VST) XR.

### BACKGROUND

Extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

### SUMMARY

This disclosure relates to guided denoising with edge preservation for video see-through (VST) extended reality (XR).

In a first embodiment, a method includes obtaining, using at least one imaging sensor of a VST XR device, an image frame. The method also includes mapping, using at least one processing device of the VST XR device, the image frame to a mesh including multiple vertices. The method further includes performing, using the at least one processing device, noise reduction to determine color data of pixels located on the vertices of the mesh, where performing the noise reduction includes using a denoising filter to denoise the image frame. The method also includes determining, using the at least one processing device, color data of remaining pixels not located on the vertices of the mesh based on the determined color data of the pixels located on the vertices to generate a denoised image. In addition, the method includes performing, using the at least one processing device, image enhancement of the denoised image to enhance at least part of the denoised image and generate an enhanced image.

In a second embodiment, a VST XR device includes at least one imaging sensor and at least one processing device. The at least one processing device is configured to obtain, using the at least one imaging sensor, an image frame and map the image frame to a mesh including multiple vertices. The at least one processing device is also configured to perform noise reduction to determine color data of pixels located on the vertices of the mesh using a denoising filter to denoise the image frame. The at least one processing device is further configured to determine color data of remaining pixels not located on the vertices of the mesh based on the determined color data of the pixels located on the vertices to generate a denoised image. In addition, the at least one processing device is configured to perform image enhancement of the denoised image to enhance at least part of the denoised image and generate an enhanced image.

In a third embodiment, a non-transitory machine readable medium contains instructions that when executed cause at least one processor of a VST XR device to obtain, using at least one imaging sensor of the VST XR device, an image frame and map the image frame to a mesh including multiple vertices. The non-transitory machine readable medium also contains instructions that when executed cause the at least one processor to perform noise reduction to determine color data of pixels located on the vertices of the mesh using a denoising filter to denoise the image frame. The non-transitory machine readable medium further contains instructions that when executed cause the at least one processor to determine color data of remaining pixels not located on the vertices of the mesh based on the determined color data of the pixels located on the vertices to generate a denoised image. In addition, the non-transitory machine readable medium contains instructions that when executed cause the at least one processor to perform image enhancement of the denoised image to enhance at least part of the denoised image and generate an enhanced image.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112 (f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIG. 2 illustrates an example process for guided denoising with edge preservation for video see-through (VST) extended reality (XR) in accordance with this disclosure;

FIG. 3 illustrates an example architecture supporting guided denoising with edge preservation for VST XR in accordance with this disclosure;

FIG. 4 illustrates an example image enhancement function for VST XR in accordance with this disclosure; and

FIG. 5 illustrates an example method for guided denoising with edge preservation for VST XR in accordance with this disclosure.

### DETAILED DESCRIPTION

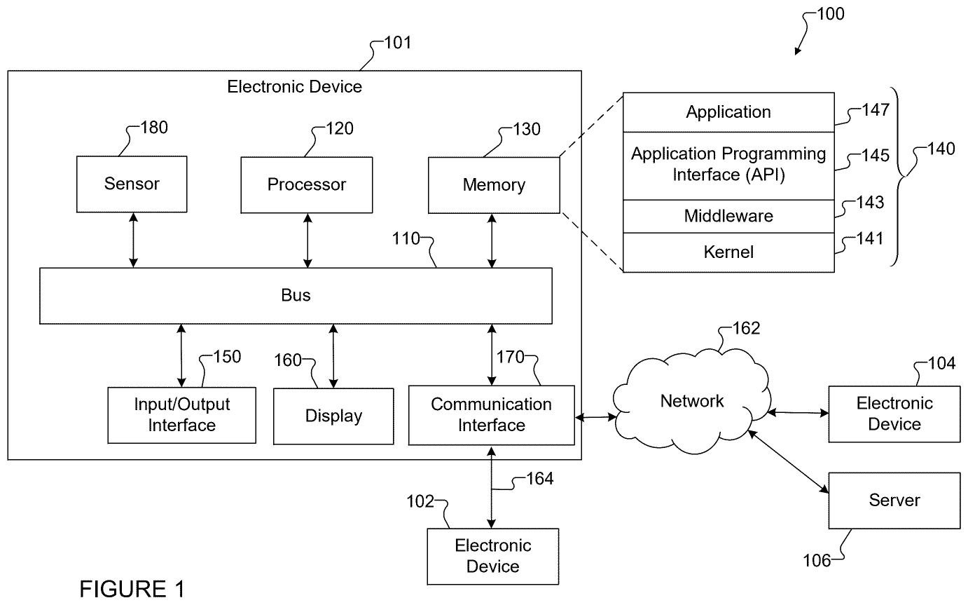

FIGS. 1 through 5, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

Optical see-through (OST) XR systems refer to XR systems in which users directly view real-world scenes through head-mounted devices (HMDs). Unfortunately, OST XR systems face many challenges that can limit their adoption. Some of these challenges include limited fields of view, limited usage spaces (such as indoor-only usage), failure to display fully-opaque black objects, and usage of complicated optical pipelines that may require projectors, waveguides, and other optical elements. In contrast to OST XR systems, video see-through (VST) XR systems (also called “passthrough” XR systems) present users with generated video sequences of real-world scenes. VST XR systems can be built using virtual reality (VR) technologies and can have various advantages over OST XR systems. For example, VST XR systems can provide wider fields of view and can provide improved contextual augmented reality.

Unfortunately, VST XR devices can suffer from various shortcomings, many of which can affect user satisfaction. For example, in VST XR pipelines, final views are often generated by transforming image frames captured using see-through cameras, and the final views are presented to users of the VST XR devices. The quality of the see-through image frames tends to be very important to the quality of the generated final views. While image signal processors (ISPs) or image processing engines (IPEs) may be used to remove noise and enhance images, these represent additional components that increase the size, weight, power, and cost of the VST XR devices. If an image signal processor or image processing engine is not available in a VST XR pipeline, camera noise can remain in the image frames and be included in the generated final views. Noisy and blurry images presented to users may cause the users to feel uncomfortable or even experience motion sickness.

This disclosure provides various techniques supporting guided denoising with edge preservation for VST XR. As described in more detail below, an image frame can be obtained using at least one imaging sensor of a VST XR device. The image frame can be mapped to a mesh that includes multiple vertices, and noise reduction can be performed for the image frame to determine color data of pixels located on the vertices of the mesh. For example, the noise reduction could be performed using a denoising filter to denoise the image frame. In some cases, weights used by the denoising filter can be based on the image frame or information associated with the image frame, such as when the weights are based on at least one of image intensity data associated with the image frame, an image feature map associated with the image frame, a depth map associated with the image frame, a depth feature map associated with the image frame, or spatial information associated with the image frame. Color data of remaining pixels not located on the vertices of the mesh can be determined based on the determined color data of the pixels located on the vertices to generate a denoised image. Image enhancement of the denoised image can be performed to enhance at least part of the denoised image and generate an enhanced image. This can be repeated across any number of image frames, such as image frames captured using left and right see-through cameras of the VST XR device.

In this way, the disclosed techniques provide an efficient mechanism to address noise and other issues affecting the quality of image frames captured using a VST XR device. Among other things, the disclosed techniques enable the use of an efficient algorithm to reduce noise and enhance image frames. The resulting increase in image quality can be achieved by removing noise while preserving edges in the image frames. These techniques can also help to avoid blurring high-frequency image features while smoothing noise. The overall result is that final views of scenes can have a higher quality, which can increase user satisfaction and reduce or avoid problems like user discomfort or motion sickness.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to guided denoising with edge preservation for VST XR.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform guided denoising with edge preservation for VST XR. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include cameras or other imaging sensors, which may be used to capture images of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to guided denoising with edge preservation for VST XR.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

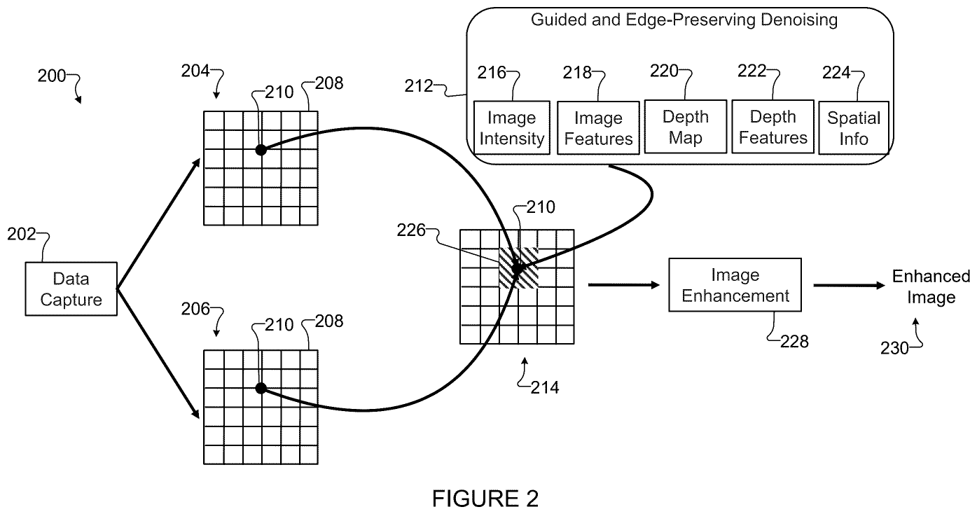

FIG. 2 illustrates an example process 200 for guided denoising with edge preservation for VST XR in accordance with this disclosure. For ease of explanation, the process 200 of FIG. 2 is described as being performed using the electronic device 101 in the network configuration 100 of FIG. 1. However, the process 200 may be performed using any other suitable device(s) and in any other suitable system(s).

As shown in FIG. 2, a data capture function 202 is used to obtain at least one image frame 204. For example, the data capture function 202 can involve obtaining see-through image frames 204 captured using one or more see-through cameras or other imaging sensors 180 of a VST XR device. In some cases, the data capture function 202 may be used to obtain image frames 204 at a desired frame rate, such as 30, 60, 90, or 120 frames per second. The data capture function 202 may also be used to obtain image frames 204 from any suitable number of imaging sensors 180, such as from left and right see-through cameras. Each image frame 204 can have any suitable size, shape, and resolution and include image data in any suitable domain. As particular examples, each image frame 204 may include RGB image data, YUV image data, or Bayer or other raw image data.

The data capture function 202 can also optionally be used to obtain at least one depth map 206 or other depth data related to the image frames 204 being captured. For instance, at least one depth sensor 180 used in or with the VST XR device may capture depth data within the scene being imaged using the see-through camera(s). Any suitable type(s) of depth sensor(s) 180 may be used, such as light detection and ranging (LIDAR) or time-of-flight (ToF) depth sensors. In some cases, the depth data that is obtained can have a resolution that is less than (and possibly significantly less than) the resolution of the captured image frames 204. For example, the depth data may have a resolution that is equal to or less than half a resolution of each of the captured image frames 204. As a particular example, the captured image frames 204 may have a 3K or 4K resolution, and the depth maps 206 may have a resolution of 320 depth values by 320 depth values or 480 depth values by 480 depth values.

Each image frame 204 is mapped onto a rendering mesh 208, and each depth map 206 may optionally be mapped onto the rendering mesh 208. Each rendering mesh 208 represents a grid or other mesh pattern in which various lines meet at various vertices. Each rendering mesh 208 can vary depending on the scene being imaged, such as when each rendering mesh 208 defines the contours of three-dimensional (3D) content within the associated image frame 204. Rendering meshes 208 can be generated in various ways, and the rendering meshes 208 can be applied to the image frames 204 and optionally to the depth maps 206 in order to identify which pixel data or depth data lies on the vertices 210 of the rendering meshes 208.

A guided and edge-preserving denoising function 212 can be used to process each image frame 204 and optionally its associated depth map 206 in order to generate a denoised image 214 for each image frame 204. Each denoised image 214 represents the corresponding image frame 204 with reduced noise included in its image data. Even if some noise remains in the denoised images 214, the denoised images 214 are cleaner and have less noise than the original image frames 204. As described in more detail below, the denoising function 212 can use information from or associated with the image frames 204 in order to denoise the image frames 204, which is why the denoising function 212 is referred to as being “guided.” Moreover, the denoising function 212 can be used to maintain textures and other edges contained in the image frames 204, which is why the denoising function 212 is referred to as being “edge-preserving.”

As shown here, the denoising function 212 may use various types of information when performing denoising. In this particular example, the denoising function 212 may use image intensity information 216, which represents the intensities of various pixels or other portions of each image frame 204. The denoising function 212 may use image features 218, which represent higher-frequency components of each image frame 204. The denoising function 212 may use depth maps 220, which identify depths within each image frame 204. Note that the depth maps 220 may or may not represent the depth maps 206. In some cases, for instance, the depth maps 206 may be combined with depths determined in other ways (such as depths determined using disparities in stereo image pairs) in order to increase the resolution of the depth data and produce dense depth maps 220, which is often referred to as depth densification. The denoising function 212 may use depth features 222, which represent higher-frequency components of each depth map 206 or 220 or other depth data. The denoising function 212 may use spatial information 224, which refers to information that identifies spatial characteristics of the 3D contents in the image frames 204. Note that while all five types of information 216-224 are shown here, the denoising function 212 may use one, any subcombination, or all of the various types of information 216-224 when performing denoising depending on the implementation.

For each image frame 204, the denoising function 212 can perform denoising for pixels located on the vertices 210 of the rendering mesh 208 for that image frame 204. For example, for each specified pixel located on a vertex 210 of the rendering mesh 208, the denoising function 212 may generate a weighted average of pixel values within a neighborhood 226 around that pixel. For each specified pixel not located on a vertex 210 of the rendering mesh 208, the denoising function 212 can determine a pixel value for that specified pixel using the pixel values of the pixels on the vertices 210 around the specified pixel, such as by interpolating the values of the pixels on the vertices 210 within the neighborhood 226 around the specified pixel or otherwise suitably close to the specified pixel. Thus, the denoising function 212 may identify pixel values for the pixels located on the vertices 210, and the denoising function 212 may perform interpolation using those pixel values in order to generate pixel values for the pixels not located on the vertices 210. This results in the generation of each denoised image 214, which contains less noise than its corresponding image frame 204 while preserving edges contained in the corresponding image frame 204. Thus, the rendering meshes 208 here can be beneficial in that they can help to save computational resources and improve performance (compared to denoising all image data at all pixels in the image frames 204).

In some embodiments, the denoising function 212 is implemented using a denoising filter, where the denoising filter applies various weights to pixel values in order to generate filtered pixel values. As a particular example, the filtered pixel values generated using the denoising filter may be expressed as follows.

[symbol]

Pixel [symbol] _update= [symbol] ( [symbol] Pixels [symbol] _Neighborhood, [symbol] Weight [symbol] _Image Intensity, [symbol] Weight [symbol] _Image Features, [symbol] Weight [symbol] _Depth, [symbol] Weight [symbol] _Depth Feature, [symbol] Weight [symbol] _Spatial Info)

Here, Pixel_{update} represents each denoised pixel, and Pixels_{Neighborhood} represents the pixel values in the associated neighborhood 226 around that denoised pixel. Also, [symbol] (⋅) represents operation of the denoising filter, which can be constructed and apply one or more weights to the pixel values in the associated neighborhood 226. Again, this assumes that all five types of information 216-224 are used to guide the denoising function 212, so there are five weights associated with the [symbol] (⋅) expression. If one or some (but not all) of the various types of information 216-224 are used, the [symbol] (⋅) expression would be based on a different set of weights.

Each denoised image 214 is provided to an image enhancement function 228, which enhances various features in the denoised image 214 in order to generate an enhanced image 230. For example, the image enhancement function 228 can enhance various high-frequency features or other features in each denoised image 214 (such as features of objects or text) to improve the clarity of each resulting enhanced image 230. Among other things, this can help to improve the readability of text captured in the image frames 204. The image enhancement function 228 can use any suitable technique for enhancing images, one example of which is provided below.

Although FIG. 2 illustrates one example of a process 200 for guided denoising with edge preservation for VST XR, various changes may be made to FIG. 2. For example, various components or functions in FIG. 2 may be combined, further subdivided, replicated, omitted, or rearranged and additional components or functions may be added according to particular needs. Also, the meshes shown in FIG. 2 are simplified for ease of illustration and explanation, and each mesh may include any suitable number of lines and any suitable number of vertices.

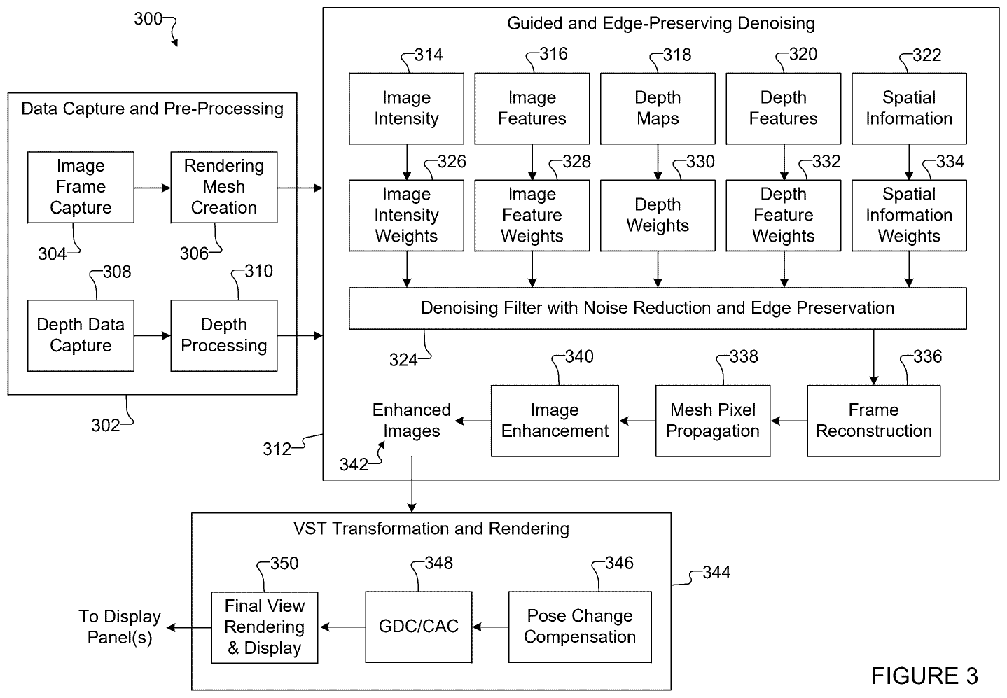

FIG. 3 illustrates an example architecture 300 supporting guided denoising with edge preservation for VST XR in accordance with this disclosure. For ease of explanation, the architecture 300 of FIG. 3 is described as being implemented using the electronic device 101 in the network configuration 100 of FIG. 1, such as to implement the process 200 shown in FIG. 2. However, the architecture 300 may be implemented using any other suitable device(s) and in any other suitable system(s), and the architecture 300 may be used to implement any other suitable process designed in accordance with this disclosure.

As shown in FIG. 3, the architecture 300 includes a data capture and pre-processing operation 302, which generally operates to obtain image frames 204 and optionally other data (such as depth maps 206) and pre-process the obtained data. In some embodiments, the data capture and pre-processing operation 302 may implement the data capture function 202 described above. In this example, the data capture and pre-processing operation 302 includes an image frame capture function 304, which generally operates to obtain image frames of a scene. For example, the image frame capture function 304 can be used to obtain see-through image frames 204, such as from one or more see-through cameras or other imaging sensors 180 of a VST XR device.

The captured image frames 204 are provided to a rendering mesh creation function 306, which generally operates to identify a rendering mesh 208 for each image frame 204. The rendering mesh 208 for an image frame 204 can be based on contours of 3D content within each image frame 204. In some cases, the rendering mesh 208 for one image frame 204 in a sequence can be based on the rendering mesh 208 for a prior image frame 204 in the sequence. Thus, for instance, each rendering mesh 208 can include lines and vertices 210, and certain vertices 210 may move from one image frame 204 to the next depending on changes within the scene and changes of the position of the VST XR device. The rendering mesh creation function 306 can use any suitable technique to identify rendering meshes 208 for image frames 204. The rendering mesh creation function 306 can also map each rendering mesh 208 onto the associated image frame 204. For instance, the rendering mesh creation function 306 can determine which pixels of each image frame 204 fall on the vertices 210 of the associated rendering meshes 208.

The data capture and pre-processing operation 302 also optionally includes a depth data capture function 308, which generally operates to obtain depth-related information associated with depths within the scene captured in the image frames 204. For example, the depth data capture function 308 can be used to obtain the depth maps 206, such as by using one or more depth sensors 180 of the VST XR device. A depth processing function 310 generally operates to pre-process the obtained depth data, such as by mapping each depth map 206 or other depth data onto the associated rendering mesh 208. For instance, the depth processing function 310 can determine which depth values of each depth map 206 fall on the vertices 210 of the associated rendering mesh 208.

A guided and edge-preserving denoising operation 312 generally operates to process the obtained image frames 204 in order to generate enhanced images 342, which could represent the enhanced images 230 discussed above. In some embodiments, the guided and edge-preserving denoising operation 312 may implement the guided and edge-preserving denoising function 212 described above. As shown in this example, the guided and edge-preserving denoising operation 312 obtains or has access to one or more types of information from or related to the image frames 204 being processed. For example, the guided and edge-preserving denoising operation 312 may obtain or have access to image intensity information 314, image features 316, depth maps 318, depth features 320, and spatial information 322 (or any one or combination thereof). These types of information 314-322 may be the same as or similar to the corresponding types of information 216-224 shown in FIG. 2 and described above.

The guided and edge-preserving denoising operation 312 here applies a denoising filter 324 to the image frames 204 in order to generate the denoised images 214. For example, the denoising filter 324 can be applied to the image data in each pre-processed image frame 204 in order to remove noise from the pre-processed image frame 204 and generate a corresponding denoised image 214. The denoising filter 324 here is a guided filter. More specifically, the denoising filter 324 is guided by the pre-processed image frames 204 being filtered. This is accomplished by using weights 326-334, which can be respectively applied to the various types of information 314-322 that are available and used with each image frame 204. The determination of which weight or weights 326-334 are used here depends on which type or types of information 314-322 are available. Thus, if one or a subset of the types of information 314-322 are available, one or a subset of the weights 326-334 may be used.

The weight or weights 326-334 that are used can be applied by the denoising filter 324 to the pixel values within the neighborhood 226 around each pixel falling on a vertex 210 of the associated rendering mesh 208. As a particular example, multiple weights 326-334 may be used to generate a weighted average of the pixel values within the neighborhood 226 around each pixel falling on a vertex 210 of the associated rendering mesh 208. The weighted average or other results generated using the denoising filter 324 represent image data with reduced noise. Because the denoising filter 324 is guided by information like image intensities, image features, depths, depth features, and/or spatial information, image edges and image features can be preserved more effectively in the denoised images 214.

In some cases, the denoising filter 324 may operate on individual color channels of each image frame 204. For example, the denoising filter 324 may be applied to the red, green, and blue color channels of each image frame 204 in order to generate red image data with reduced noise, green image data with reduced noise, and blue image data with reduced noise. In some embodiments, the operation of the denoising filter 324 operating on different color channels may be expressed as follows.

R′←(wᵢᵢ,w_{if},w_{dm},w_{df},wₛᵢ,R)

G′←F(wᵢᵢ,w_{if},w_{dm},w_{df},wₛᵢ,G)

B′←F(wᵢᵢ,w_{if},w_{dm},w_{df},wₛᵢ,B)

Here, R, G, and B represent the original red, green, and blue image data, and R′, G′, and B′ represent the filtered red, green, and blue image data. Also, F(⋅) represents a function that applies at least one of the weights 326-334 (respectively denoted wᵢᵢ, w_{if}, w_{dm}, w_{df}, and wₛᵢ) to the red, green, and blue image data. When the color channels of each image frame 204 are filtered separately, a frame reconstruction function 336 can be used to combine the filtered color channels for each image frame 204 back into an integrated denoised image 214.

Each resulting denoised image 214 generated using the denoising filter 324 (and optionally using the frame reconstruction function 336) can include filtered image data on the vertices 210 of the associated rendering mesh 208. For each image frame 204, a mesh pixel propagation function 338 generally operates to propagate pixel values for the pixels located at the vertices 210 of the rendering mesh 208 to other pixels not located at the vertices 210 of the rendering mesh 208. In some cases, for each specified pixel not located at a vertex 210 of the associated rendering mesh 208, the mesh pixel propagation function 338 may perform interpolation or other combination of pixel values for pixels that are located within the neighborhood 226 around the specified pixel or that are otherwise suitably close to the specified pixel.

The resulting denoised images 214 are provided to an image enhancement function 340, which generally operates to enhance the denoised images 214 and generate the enhanced images 342. In some embodiments, the image enhancement function 340 may implement the image enhancement function 228 described above. The image enhancement function 340 can use any suitable technique to enhance images. In some cases, for example, the image enhancement function 340 may, for each denoised image 214, determine high-frequency details of the denoised image 214, determine a blurriness level of the denoised image 214, and integrate the high-frequency details of the denoised image 214 and the denoised image 214 based on a scale factor, where the scale factor is based on or otherwise corresponds to the blurriness level. This helps to reinforce/enhance/sharpen the high-frequency details (image features) of each denoised image 214, such as by extracting and enhancing the high-frequency image features and then re-inserting the enhanced high-frequency image features back into the denoised image 214. Moreover, the blurriness level can be used to control the strength of the enhancement of the high-frequency image features, such as when higher strengths are used with higher blurriness levels (since it may not be desired to overly enhance image content with low blur).

The enhanced images 342 are provided to a VST transformation and rendering operation 344, which generally operates to create final views of the scene captured in the image frames 204 and render the final views for presentation to a user of a VST XR device. In this example, the VST transformation and rendering operation 344 includes a pose change compensation function 346, which generally operates to modify the enhanced images 342 based on a predicted head pose of the user. For example, there is typically a delay between capture of the image frames 204 and display of rendered images based on those captured image frames 204, and it is possible for the user to move his or her head during that intervening time period. The pose change compensation function 346 can use information (such as from an IMU, tracking camera, or other data) to predict how the user's head pose is expected to change between capture of the image frames 204 and display of rendered images based on those captured image frames 204. The pose change compensation function 346 can also apply a suitable transformation to each enhanced image 342, such as by rotating and/or translating each enhanced image 342, so that the transformed images are suitable for presentation at the user's predicted head pose.

A geometric distortion correction (GDC)/chromatic aberration correction (CAC) function 348 can modify the enhanced images 342 to account for distortions created in displayed images. For instance, in many VST XR devices, rendered images are presented on one or more display panels (such as one or more displays 160), and rendered images are often viewed by the user through left and right display lenses positioned between the user's eyes and the display panel(s). However, the display lenses may create geometric distortions when displayed images are viewed, and the display lenses may create chromatic aberrations when light passes through the display lenses. The GDC/CAC function 348 can make adjustments to the enhanced images 342 so that the resulting images pre-compensate for the expected geometric distortions and chromatic aberrations. Thus, the GDC/CAC function 348 may determine how images should be pre-distorted to compensate for the subsequent geometric distortions and chromatic aberrations created when the images are displayed and viewed through the display lenses. In some cases, the GDC/CAC function 348 may operate based on a display lens GDC and CAC model, which can mathematically represent the geometric distortions and chromatic aberrations created by the display lenses.

A final view rendering and display function 350 can process the corrected images and perform any additional refinements or modifications needed or desired, and the resulting images can represent the final views of the scene. For example, a 3D-to-2D warping can be used to warp the final views of the scene into 2D images. The final view rendering and display function 350 can also present the rendered images to the user. For instance, the final view rendering and display function 350 can render the images into a form suitable for transmission to at least one display 160 and can initiate display of the rendered images, such as by providing the rendered images to one or more displays 160.

Among other things, the architecture 300 can provide the following advantages or benefits depending on the implementation. The architecture 300 can use a denoising filter 324 that is guided by one or more types of image-related information. As a result, the architecture 300 is able to perform denoising by refining pixel values based on neighborhood pixels (such as by using weighted averages of neighborhood pixels) while preserving edges. The architecture 300 can also efficiently map pixel values onto rendering meshes 208 and interpolate or otherwise propagate denoised pixel values on the vertices 210 of the rendering meshes 208 to other pixel locations, providing high performance and saving computational resources in generating rendered images. In addition, the architecture 300 can support improved readability or otherwise support higher image clarity by performing image enhancement, which can occur after denoising so that the image enhancement enhances actual image contents without significantly enhancing noise.

The following now describes how certain operations within the architecture 300 may be designed or performed. Operation of the denoising filter 324 can be denoted as [symbol] (⋅), and the denoising filter 324 can be used to determine pixel values guided by the various types of image-related information 314-322. In some cases, the output of the denoising filter 324 may be expressed as follows.

I_output(p)= [symbol] (Image Intensity,Image Feature,Depth Map,Depth Feature,Spatial Information,I_input(p))

Here, Iₒᵤₜₚᵤₜ(p) represents an output pixel value after edge-preserving noise reduction, and Iᵢₙₚᵤₜ(p) represents an input pixel value. A guiding function may be denoted as [symbol] (⋅), and the guiding function can control how the various types of information 314-322 are used by the denoising filter 324. In some cases, the guiding function may be expressed as follows.

[symbol]

(p)= [symbol] (Image Intensity,Image Feature,Depth Map,Depth Feature,Spatial Information)

Based on this, the output of the denoising filter 324 may be rewritten as follows.

Iₒᵤₜₚᵤₜ(p)= [symbol] ( [symbol] (p),Iᵢₙₚᵤₜ(p))

In some cases, the guiding function [symbol] (⋅) can be constructed using weights 326-334 based on the various types of information 314-322 in order to leverage the effects of the different types of information 314-322. As described above, the weights 326-334 can be created from image intensities, image features, depth maps, depth features, and/or spatial information for use by the denoising filter 324.

In some embodiments, image intensity weights 326 wᵢᵢ(p,pₙ) can be created from image intensities for an image I at each pixel p using a Gaussian distribution with a normalized intensity difference between pixel p and its neighborhood pixels and the mean and standard deviation associated with the pixel values. Image feature weights 328 w_{if}(p,pₙ) can be created from image feature information I_{f} for an image I at each pixel p using a Gaussian distribution with a normalized image feature difference between pixel p and its neighborhood pixels and the mean and standard deviation associated with the image features. Depth weights 330 w_{dm}(p,pₙ) can be created from depth map information I_{d} for an image I at each pixel p using a Gaussian distribution with a normalized depth difference between pixel p and its neighborhood pixels and the mean and standard deviation associated with the depth map information. Depth feature weights 332 w_{df}(p,pₙ) can be created from depth feature information I_{df} for an image I at each pixel p using a Gaussian distribution with a normalized depth feature difference between pixel p and its neighborhood pixels and the mean and standard deviation associated with the depth feature information. Spatial weights 334 wₛᵢ(p,pₙ) can be created from spatial information for an image/at each pixel p using a Gaussian distribution with a normalized spatial difference between pixel p and its neighborhood pixels and the mean and standard deviation associated with the depth feature information.

Based on these weights 326-334, the output of the denoising filter 324 may now be expressed as follows.

$${I}_{output} ( p ) = \frac{1}{{\sum }_{{p}_{n} ∈ N ( p )} w ( p , {p}_{n} )} {\sum }_{{p}_{n} ∈ N ( p )} w ( p , {p}_{n} ) {I}_{input} ( {p}_{n} )$$

Here, Iᵢₙₚᵤₜ(pₙ) represents the value of each neighborhood pixel pₙ. Also, w (p,pₙ) represents a combined weight, which in some cases could be expressed as follows.

w(p,pₙ)=wᵢᵢ(p,pₙ)w_{if}(p,pₙ)w_{dm}(p,pₙ)w_{df}(p,pₙ)wₛᵢ(p,pₙ)

As noted above, a single type of information 314-322 or a subset of the various types of information 314-322 may be used, and the equations above may be adjusted to account for the weight(s) actually being used by the denoising filter 324. Thus, for instance, if depth data is not available, the output of the denoising filter 324 may be expressed as follows.

Iₒᵤₜₚᵤₜ(p)= [symbol] (Image Intensity,Image Feature,Spatial Information,Iᵢₙₚᵤₜ(p))

In some embodiments, the various weights 326-334 described above can be determined using a Gaussian distribution, which may be expressed as follows.

w(d)=G(d,μ,σ)

However, other distributions may be used. For instance, a simplified Gaussian distribution may be used for faster computations. Other distributions may also be used as needed or desired, and different distributions may have different effects on denoising filtering.

Although FIG. 3 illustrates one example of an architecture 300 supporting guided denoising with edge preservation for VST XR, various changes may be made to FIG. 3. For example, various components or functions in FIG. 3 may be combined, further subdivided, replicated, omitted, or rearranged and additional components or functions may be added according to particular needs.

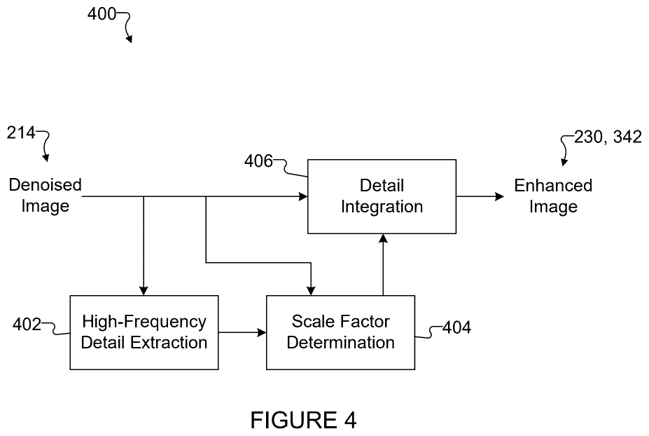

FIG. 4 illustrates an example image enhancement function 400 for VST XR in accordance with this disclosure. The image enhancement function 400 may, for example, represent an example implementation of the image enhancement function 228 of FIG. 2 or the image enhancement function 340 of FIG. 3. As shown in FIG. 4, a denoised image 214 is provided to a high-frequency detail extraction function 402, which generally operates to identify and extract high-frequency image details from the denoised image 214. The extraction function 402 can use any suitable technique to identify and extract high-frequency image details from denoised images 214. In some embodiments, for instance, the extraction function 402 may use a Laplacian of Gaussian filter in order to identify and extract the high-frequency image details. Note, however, that other techniques may be used to identify and extract the high-frequency image details.

A scaling factor determination function 404 generally operates to determine a scale factor, which is applied to the extracted high-frequency image details from the denoised image 214. For example, the scaling factor determination function 404 can determine a blurriness level of the denoised image 214, and the scale factor can be based on the determined blurriness level. As a particular example, a larger scale factor can be used when the blurriness level is higher, and a smaller scale factor can be used when the blurriness level is lower. The scaling factor determination function 404 can also apply the scale factor to the extracted high-frequency image details from the denoised image 214. This results in the generation of scaled high-frequency image details.

A detail integration function 406 generally operates to integrate the denoised image 214 with the scaled high-frequency image details in order to generate an enhanced image 230, 342 corresponding to the denoised image 214. For example, the detail integration function 406 may add pixel values of the denoised image 214 with pixel values in the scaled high-frequency image details in order to generate pixel values for the enhanced image 230, 342. This approach effectively reinforces, enhances, or otherwise sharpens the high-frequency details of the denoised image 214 so that the high-frequency details are sharper in the enhanced image 230, 342.

Although FIG. 4 illustrates one example of an image enhancement function 400 for VST XR, various changes may be made to FIG. 4. For example, various components or functions in FIG. 4 may be combined, further subdivided, replicated, omitted, or rearranged and additional components or functions may be added according to particular needs. Also, any other suitable technique for image enhancement may be used in the process 200 or in the architecture 300.

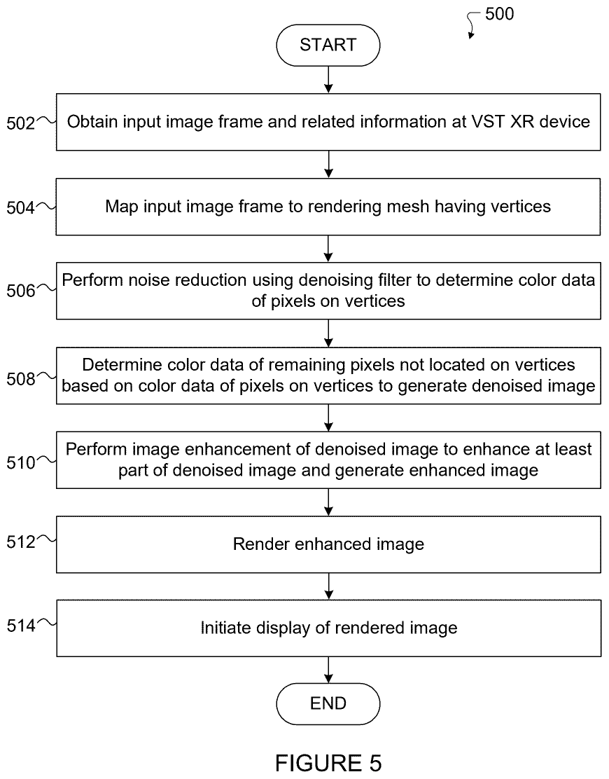

FIG. 5 illustrates an example method 500 for guided denoising with edge preservation for VST XR in accordance with this disclosure. For ease of explanation, the method 500 of FIG. 5 is described as being performed using the electronic device 101 in the network configuration 100 of FIG. 1, where the electronic device 101 can implement the architecture 300 of FIG. 3 and perform the process 200 of FIG. 2. However, the method 500 may be performed using any other suitable device(s) and in any other suitable system(s).

As shown in FIG. 5, an input image frame and related information is obtained at a VST XR device at step 502. This may include, for example, the processor 120 of the electronic device 101 obtaining an image frame 204 using a see-through camera or other imaging sensor 180 of the electronic device 101. This may also include the processor 120 of the electronic device 101 generating or otherwise obtaining one or more types of information 216-224, 314-322 related to the image frame 204. The input image frame is mapped to a rendering mesh having various vertices at step 504. This may include, for example, the processor 120 of the electronic device 101 mapping the pixels of the image frame 204 to a rendering mesh 208 in order to identify which pixels of the image frame 204 are located at vertices 210 of the rendering mesh 208.

Noise reduction is performed to determine color data of pixels located on the vertices of the rendering mesh at step 506. This may include, for example, the processor 120 of the electronic device 101 performing the noise reduction using the denoising filter 324. In some cases, the denoising filter 324 can generate a weighted average for each pixel located on a vertex 210 of the rendering mesh 208, such as a weighted average of pixels in a neighborhood 226 around that pixel. Also, in some cases, the denoising filter 324 may be configured to denoise the image frame 204 using weights 326-334 that are based on at least one of image intensity data associated with the image frame 204, an image feature map associated with the image frame 204, a depth map associated with the image frame 204, a depth feature map associated with the image frame 204, or spatial information associated with the image frame 204. The denoising here can be done for the pixels located on the vertices 210 of the rendering mesh 208, which can help to reduce the number of computations performed. Note that the noise reduction here can involve performing the denoising using the denoising filter 324 without losing edge information in the image frame 204.

Color data of remaining pixels that are not located on the vertices of the rendering mesh are determined based on the color data of the pixels on the vertices of the rendering mesh at step 508. This may include, for example, the processor 120 of the electronic device 101 performing interpolation or another function to estimate the color data of each pixel not located on the vertices 210 of the rendering mesh 208 based on the color data of nearby pixels located on vertices 210 of the rendering mesh 208. This results in the generation of a denoised image 214.

Image enhancement of the denoised image is performed to enhance at least part of the denoised image at step 510. This may include, for example, the processor 120 of the electronic device 101 enhancing high-frequency image details of the denoised image 214. As a particular example, this may include the processor 120 of the electronic device 101 determining high-frequency details of the denoised image 214 (such as by using a Laplacian of Gaussian filter), determining a blurriness level of the denoised image 214, and integrating the high-frequency details of the denoised image 214 and the denoised image 214 based on a scale factor corresponding to the blurriness level. Note that the image enhancement here can involve enhancing image features and text. This results in the generation of an enhanced image 230, 342.

The enhanced image is rendered at step 512, and display of the resulting rendered image is initiated at step 514. This may include, for example, the processor 120 of the electronic device 101 rendering the enhanced image 230, 342 and displaying the rendered image on at least one display 160 of the electronic device 101.

Although FIG. 5 illustrates one example of a method 500 for guided denoising with edge preservation for VST XR, various changes may be made to FIG. 5. For example, while shown as a series of steps, various steps in FIG. 5 may overlap, occur in parallel, occur in a different order, or occur any number of times (including zero times). Also, the method 500 may be repeated for any number of image frames 204, such as for each of multiple image frames 240 captured using left and right see-through cameras or other imaging sensors 180 of the VST XR device.

It should be noted that the functions shown in or described with respect to FIGS. 2 through 5 can be implemented in an electronic device 101, 102, 104, server 106, or other device(s) in any suitable manner. For example, in some embodiments, at least some of the functions shown in or described with respect to FIGS. 2 through 5 can be implemented or supported using one or more software applications or other software instructions that are executed by the processor 120 of the electronic device 101, 102, 104, server 106, or other device(s). In other embodiments, at least some of the functions shown in or described with respect to FIGS. 2 through 5 can be implemented or supported using dedicated hardware components. In general, the functions shown in or described with respect to FIGS. 2 through 5 can be performed using any suitable hardware or any suitable combination of hardware and software/firmware instructions. Also, the functions shown in or described with respect to FIGS. 2 through 5 can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
obtaining, using at least one imaging sensor of a video see-through (VST) extended reality (XR) device, an image frame;
mapping, using at least one processing device of the VST XR device, the image frame to a mesh comprising multiple vertices;
performing, using the at least one processing device, noise reduction to determine color data of pixels located on the vertices of the mesh, wherein performing the noise reduction comprises using a denoising filter to denoise the image frame;
determining, using the at least one processing device, color data of remaining pixels not located on the vertices of the mesh based on the determined color data of the pixels located on the vertices to generate a denoised image; and
performing, using the at least one processing device, image enhancement of the denoised image to enhance at least part of the denoised image and generate an enhanced image.

2. The method of claim 1, wherein the denoising filter is configured to denoise the image frame using weights that are based on at least one of: image intensity data associated with the image frame, an image feature map associated with the image frame, a depth map associated with the image frame, a depth feature map associated with the image frame, or spatial information associated with the image frame.

3. The method of claim 1, wherein determining the color data of the remaining pixels comprises interpolating each remaining pixel based on color data of one or more neighboring pixels of that remaining pixel.

4. The method of claim 1, wherein performing the image enhancement comprises:
determining high-frequency details of the denoised image;
determining a blurriness level of the denoised image; and
integrating the high-frequency details of the denoised image and the denoised image based on a scale factor corresponding to the blurriness level.

5. The method of claim 4, wherein determining the high-frequency details of the image frame comprises using a Laplacian of Gaussian filter.

6. The method of claim 1, wherein:
performing the noise reduction comprises denoising the image frame using the denoising filter without losing edge information in the image frame; and
performing the image enhancement comprises enhancing image features and text contained in the enhanced image relative to the denoised image.

7. The method of claim 1, further comprising:
rendering the enhanced image for display on at least one display panel of the VST XR device.

8. A video see-through (VST) extended reality (XR) device comprising:
at least one imaging sensor; and
at least one processing device configured to:
obtain, using the at least one imaging sensor, an image frame;
map the image frame to a mesh comprising multiple vertices;
perform noise reduction to determine color data of pixels located on the vertices of the mesh using a denoising filter to denoise the image frame;
determine color data of remaining pixels not located on the vertices of the mesh based on the determined color data of the pixels located on the vertices to generate a denoised image; and
perform image enhancement of the denoised image to enhance at least part of the denoised image and generate an enhanced image.

9. The VST XR device of claim 8, wherein the denoising filter is configured to denoise the image frame using weights that are based on at least one of: image intensity data associated with the image frame, an image feature map associated with the image frame, a depth map associated with the image frame, a depth feature map associated with the image frame, or spatial information associated with the image frame.

10. The VST XR device of claim 8, wherein, to determine the color data of the remaining pixels, the at least one processing device is configured to interpolate each remaining pixel based on color data of one or more neighboring pixels of that remaining pixel.

11. The VST XR device of claim 8, wherein, to perform the image enhancement, the at least one processing device is configured to:
determine high-frequency details of the denoised image;
determine a blurriness level of the denoised image; and
integrate the high-frequency details of the denoised image and the denoised image based on a scale factor corresponding to the blurriness level.

12. The VST XR device of claim 11, wherein, to determine the high-frequency details of the image frame, the at least one processing device is configured to use a Laplacian of Gaussian filter.

13. The VST XR device of claim 8, wherein:
to perform the noise reduction, the at least one processing device is configured to denoise the image frame using the denoising filter without losing edge information in the image frame; and
to perform the image enhancement, the at least one processing device is configured to enhance image features and text contained in the enhanced image relative to the denoised image.

14. The VST XR device of claim 8, wherein the at least one processing device is further configured to render the enhanced image for display on at least one display panel of the VST XR device.

15. A non-transitory machine readable medium containing instructions that when executed cause at least one processor of a video see-through (VST) extended reality (XR) device to:
obtain, using at least one imaging sensor of the VST XR device, an image frame;
map the image frame to a mesh comprising multiple vertices;
perform noise reduction to determine color data of pixels located on the vertices of the mesh using a denoising filter to denoise the image frame;
determine color data of remaining pixels not located on the vertices of the mesh based on the determined color data of the pixels located on the vertices to generate a denoised image; and
perform image enhancement of the denoised image to enhance at least part of the denoised image and generate an enhanced image.

16. The non-transitory machine readable medium of claim 15, wherein the denoising filter is configured to denoise the image frame using weights that are based on at least one of: image intensity data associated with the image frame, an image feature map associated with the image frame, a depth map associated with the image frame, a depth feature map associated with the image frame, or spatial information associated with the image frame.

17. The non-transitory machine readable medium of claim 15, wherein the instructions that when executed cause at least one processor to determine the color data of the remaining pixels comprise:
instructions that when executed cause at least one processor to interpolate each remaining pixel based on color data of one or more neighboring pixels of that remaining pixel.

18. The non-transitory machine readable medium of claim 15, wherein the instructions that when executed cause at least one processor to perform the image enhancement comprise:
instructions that when executed cause at least one processor to:
determine high-frequency details of the denoised image;
determine a blurriness level of the denoised image; and
integrate the high-frequency details of the denoised image and the denoised image based on a scale factor corresponding to the blurriness level.

19. The non-transitory machine readable medium of claim 18, wherein the instructions that when executed cause at least one processor to determine the high-frequency details of the image frame comprise:
instructions that when executed cause at least one processor to use a Laplacian of Gaussian filter.

20. The non-transitory machine readable medium of claim 15, wherein:
the instructions that when executed cause at least one processor to perform the noise reduction comprise:
instructions that when executed cause at least one processor to denoise the image frame using the denoising filter without losing edge information in the image frame; and
the instructions that when executed cause at least one processor to perform the image enhancement comprise:
instructions that when executed cause at least one processor to enhance image features and text contained in the enhanced image relative to the denoised image.
